(19) United States
(12) Patent Application Publication
(10) Pub. No.: US 2024/0396358 A1
(43) Pub. Date: Nov. 28, 2024

(54) CHARGING METHOD AND CHARGING ARRANGEMENT FOR AN ENERGY RESERVE STORE

(71) Applicant: Robert Bosch GmbH, Stuttgart (DE)

(72) Inventor: Hartmut Schumacher, Freiberg (DE)

(21) Appl. No.: 18/693,679

(22) PCT Filed: Oct. 19, 2022
(86) PCT No.: PCT/EP2022/079016

§ 371 Date: Mar. 20, 2024

(30) Foreign Application Priority Data
Nov. 8, 2021 (DE) 10 2021 212 511.5

(51) Int. Cl. H02J 7/00; H02J 7/34

(52) U.S. Cl. CPC H02J 7/007182; H02J 7/0034; H02J 7/0047; H02J 7/345; H02J 2207/50

(57) ABSTRACT

A charging method for an energy reserve store. The charging method is performed in multiple stages with at least two charging phases. For a first charging phase, a first voltage setpoint is specified and applied, the first voltage setpoint being less than a target voltage value. In the first charging phase, a charging current is specified and set at a first current value which charges the energy reserve store to the first voltage setpoint in the first charging phase. For a further charging phase, a further voltage setpoint for the input voltage is specified and applied, which further voltage setpoint is greater than the first voltage setpoint. In the further charging phase, a further current value for the charging current is specified and is set in the charging circuit, which further current value charges the energy reserve store to the further voltage setpoint in the further charging phase.

### FIELD

The present invention relates to a charging method for an energy reserve store, which is in particular used in a personal safety system of a vehicle. The present invention also relates to a charging arrangement for an energy reserve store for carrying out such a charging method.

### BACKGROUND INFORMATION

Personal protection systems which are designed as airbag systems for vehicles and comprise a control device and an energy reserve store are described in the related art. The energy reserve store supplies energy to the airbag system in the event of a failure of the energy supply of the vehicle, so that, in the event of an accident, a triggering decision can be made and corresponding personal protection means, such as airbags, belt tensioners, etc. can be activated. In conventional airbag systems, charging arrangements for the energy reserve store, which define the charging current, for example via corresponding programming, are used to charge the energy reserve store.

Such charging arrangements generally comprise a step-up voltage transformer, which increases a battery voltage available in the vehicle from, for example, approximately 12 volts at the input to an output voltage, used to supply the airbag system, in the range of 23 volts to 40 volts, and a charging circuit, which charges the energy reserve store to voltages in the range of 23 volts to 40 volts. This can result in high losses on a controlling element of the charging circuit, in particular in a fully discharged energy reserve store, as is usually the case with a restart of the vehicle, which losses can lead to a corresponding large dimensioning of a surface area of the corresponding semiconductor chip used as the charging circuit. These high losses are caused by a charging current and a voltage difference between an output of the charging circuit and an output of the step-up voltage transformer, which is electrically connected to an input of the charging circuit.

### SUMMARY

A charging method for an energy reserve store with features of the present invention and a charging arrangement for an energy reserve store with the features of the present invention each may have the advantage that a necessary surface area for implementing an integrated semiconductor chip designed as a charging circuit can be minimized by reducing its power loss, without diminishing its performance capability in terms of charging current level and charging speed.

A feature of the present invention is to divide the charging method for an energy store into multiple charging phases and to specify an output voltage generated in the corresponding charging arrangements for an energy reserve store by a step-up voltage transformer not fixedly but variably for the entire charging process, which output voltage is used by a downstream charging circuit as the regulated voltage. This can reduce or minimize a voltage drop on the charging circuit or across a controlling member of the charging circuit or the corresponding power loss.

Example embodiments of the present invention provide a charging method for an energy reserve store. According to an example embodiment of the present invention, the charging method is performed in multiple stages with at least two charging phases, wherein, for a first charging phase, a first voltage setpoint for an input voltage of a charging circuit is specified and applied to the input of the charging circuit, which voltage setpoint is less than a target voltage value of an energy reserve voltage to which the charging circuit is to charge the energy reserve store. In the first charging phase, a charging current is specified at a first current value and is set in the charging circuit, which charging current charges the energy reserve store to the first voltage setpoint in the first charging phase. For at least one further charging phase, at least one further voltage setpoint for the input voltage of the charging circuit is specified and applied to the input of the charging circuit, which further voltage setpoint is greater than the first voltage setpoint. In the at least one further charging phase, at least one further current value for the charging current is specified and is set in the charging circuit, which further current value charges the energy reserve store to the at least one further voltage setpoint in the at least one further charging phase.

Also provided according to the present invention is a charging arrangement for an energy reserve store. According to an example embodiment of the present invention, the charging arrangement includes a central evaluation and control unit, which is designed to determine a charging strategy for the energy reserve store and to specify system-compatible current values for a charging current and voltage setpoints; a step-up voltage transformer, which comprises a first regulating and driver circuit with a first controlling element and a first evaluation and control unit; and a charging circuit, which comprises a second regulating and driver circuit with a second controlling element and a second evaluation and control unit. The central evaluation and control unit and the step-up voltage transformer and the charging circuit are configured to perform the charging method according to the present invention, wherein the step-up voltage transformer converts a respective battery voltage applied to the input of the step-up voltage transformer to a corresponding output voltage on the basis of the specified voltage setpoints, wherein an input voltage of the charging circuit follows the output voltage of the step-up voltage transformer.

In the present case, the evaluation and control units can be understood as electrical circuits which can process or evaluate sensed measurement signals. The evaluation and control units can each have at least one interface, which can be designed in hardware and/or software. In the case of a hardware design, the interfaces can, for example, be part of a so-called system ASIC, which includes a variety of functions of the evaluation and control units. However, it is also possible for the interfaces to be separate integrated circuits or to consist at least partially of discrete components. In the case of a software design, the interfaces can be software modules which are, for example, provided on a microcontroller in addition to other software modules. Also advantageous is a computer program product comprising program code that is stored on a machine-readable carrier, such as a semiconductor memory, a hard disk memory, or an optical memory, and is used to carry out the evaluation when the program is executed by the evaluation and control units.

Advantageous improvements to the charging method for an energy reserve store and to the charging arrangement for an energy reserve store according to the present invention are possible as a result of the measures and developments disclosed herein.

According to an example embodiment of the present invention, it is particularly advantageous that a certain number of further charging phases with corresponding gradual voltage setpoints for the input voltage of the charging circuit can be fixedly specified. In a final charging phase of the certain number of further charging phases, the target voltage value of the energy reserve voltage can be fixedly specified as the voltage setpoint for the input voltage of the charging circuit. This allows a particularly cost-efficient and simple implementation of the charging method according to the present invention. For example, the charging method can be performed in two stages with two charging phases, wherein half the target voltage value of the energy reserve is specified as the first voltage setpoint and the target voltage value of the energy reserve is specified as the second voltage setpoint. In addition, the same current value for the charging current can be specified for both charging phases. This can achieve halving of the power loss peak value and can significantly reduce the power loss over the entire charging process. With a three-stage charging process and three voltage setpoints, the power loss in the second and third charging phases can be reduced further. Of course, the charging process of the energy reserve store can have any number of charging phases with the same or different current values for the corresponding charging current.

In an alternative embodiment of the charging method according to the present invention, in a second charging phase, the charging current can be specified at a second current value and can be set in the charging circuit, which charging current charges the energy reserve store in the second charging phase starting from the first voltage setpoint to the target voltage value of the energy reserve voltage. During the second charging phase, a current voltage value of the energy reserve voltage can be continuously sensed, wherein the at least one further voltage setpoint for the input voltage of the charging circuit can be variably specified on the basis of the sensed current voltage value of the energy reserve voltage starting from the first voltage setpoint and can be applied to the input of the charging circuit. As a result, the input voltage of the charging circuit, which input voltage is specified as the regulated voltage, can appropriately be adjusted to follow a charging progress of the energy reserve store in order to reduce or minimize a voltage drop on the charging circuit or across a controlling member of the charging circuit. This makes it possible to further reduce the power loss over the entire charging process since the voltage drop across the charging circuit can be reduced to about 1 to 2 volts.

In an advantageous embodiment of the charging method of the present invention, the first voltage setpoint for the input voltage of the charging circuit can be determined on the basis of a minimum value of an output voltage of a step-up voltage transformer, which minimum value is based on a battery voltage. Since at least one diode is generally looped into the current path between a vehicle battery, which provides the battery voltage, and the output of the step-up voltage transformer, the minimum value of the output voltage of the step-up voltage transformer is lower than the provided battery voltage by the forward voltage of the at least one looped-in diode. According to an example embodiment of the present invention, alternatively, the first voltage setpoint for the input voltage of the charging circuit may be determined on the basis of a specified minimum value of a supply voltage for a connected electronic unit. This can ensure the supply of the connected electronic unit, such as an airbag system, during the charging process of the energy reserve store. In particular, if the currently applied battery voltage is lower than the minimum value of the supply voltage for the connected electronic unit, the first voltage setpoint for the input voltage of the charging circuit can be set to this minimum value in order to provide the supply voltage to the connected electronic unit as quickly as possible.

In a further advantageous embodiment of the charging method of the present invention, the first current value of the charging current in the first charging phase and/or the at least one further current value of the charging current in the at least one further charging phase can be set as a function of a desired charging speed. The power loss of the charging circuit in the first charging phase at an output voltage of the step-up transformer, which output voltage has the specified minimum value of the supply voltage for the connected electronic unit, can thus be reduced by setting the first current value of the charging current at 75% of the calculated charging current. This decreases the charging speed of the energy reserve in the first charging phase by 25%. In turn, this can be compensated for by a 1.5 times higher second current value of the charging current in the second charging phase in order to achieve the same total charging time of the energy reserve. Furthermore, the first current value of the charging current in the first charging phase and/or the at least one further current value of the charging current in the at least one further charging phase can be specified as a function of a maximum possible output current of the step-up voltage transformer. This output current is dependent on the current transformation ratio of the step-up voltage transformer. In addition, the first current value of the charging current in the first charging phase and/or the at least one further current value of the charging current in the at least one further charging phase can be limited as a function of a resulting power loss in the charging circuit, which power loss is, for example, determined by a difference between the specified output voltage of the step-up voltage transformer or the input voltage of the charging circuit and the current value of the energy reserve voltage, and/or as a function of a current temperature of a corresponding regulating and driver circuit and/or of a controlling element of the charging device. The temperatures can, for example, be measured by suitable temperature sensors. This can prevent overloading of the corresponding system circuits. In order to be able to achieve as high a charging speed as possible in the different charging phases with the smallest semiconductor structures, an optimized differential voltage between the input of the charging circuit or the output of the step-up voltage transformer and the output of the charging circuit or of the energy reserve voltage is specified at a constant or also gradual current value, or a current value specified according to a function, for the charging current. In addition, a maximum possible power loss of the charging circuit or of the second controlling element can be taken into account in the specification of the charging current. In this case, the control or regulation of the charging current for achieving the maximum charging speed at a specified performance capability of the charging circuit, taking into account a minimum supply voltage of the connected electronic unit so that the operation of the connected electronic unit up to the minimum battery voltage is ensured even during the charging process of the energy reserve store, can optionally be superimposed by further regulating or control conditions. For example, the maintenance of a maximum supply current from the vehicle battery at a system start taking into account the different charging phases of the energy reserve store.

In an advantageous embodiment of the charging arrangement of the present invention, a protection diode can be looped in between the output of the step-up voltage transformer and the input of the charging circuit. This protection diode avoids destruction of the charging arrangement in the event of an internal or external short-circuit of the output voltage of the step-up voltage transformer to ground by the reverse current from the energy reserve via a backward diode of the second controlling element.

In another advantageous embodiment of the charging arrangement of the present invention, the central evaluation and control unit and the first regulating and driver circuit and the first evaluation and control unit of the step-up voltage transformer can be designed, for controlling the first controlling element of the step-up voltage transformer, to sense and evaluate a battery voltage and/or an input voltage of the step-up transformer and/or the output voltage of the step-up voltage transformer and/or the input voltage of the charging circuit and/or a current voltage level of the energy reserve voltage and/or a transformer current through the first controlling element.

In a further advantageous embodiment of the charging arrangement of the present invention, the central evaluation and control unit and the second regulating and driver circuit and the second evaluation and control unit of the charging device can be designed, for controlling the second controlling element of the charging device, to regulate the charging current according to a fixed or variable setpoint specification. For this purpose, the central evaluation and control unit and the second regulating and driver circuit and the second evaluation and control unit of the charging device can be designed, for controlling the second controlling element of the charging device, to measure and evaluate the charging current in the charging direction and/or the discharging direction and/or to measure and evaluate the current voltage of the energy reserve store and/or to measure and evaluate a temperature of the second controlling element and/or of the second regulating and driver circuit and/or to calculate the power loss of the second controlling element. The charging current in the different charging phases can thereby be kept within a permitted tolerance band, which is specified from a level of the battery voltage or supply voltage of the vehicle and a permitted temperature limit or load limit of the charging circuit, wherein the charging current can be set continuously or in stepped stages tailored to the maximum possible value within the permitted tolerance band, in order to achieve a maximum charging speed.

In a further advantageous embodiment of the charging arrangement of the present invention, a communication link for data exchange between the first evaluation and control unit of the step-up voltage transformer and the second evaluation and control unit of the charging circuit can be formed. As a result, additional coordination between the first evaluation and control unit of the step-up voltage transformer and the second evaluation and control unit of the charging circuit during an automatic charging process is possible.

Exemplary embodiments of the present invention are shown in the figures and are explained in more detail in the following description. In the figures, identical reference signs denote components or elements that perform identical or analogous functions.

### BRIEF DESCRIPTION OF THE DRAWINGS

FIG. 1 shows a schematic circuit diagram of an exemplary embodiment of a charging arrangement according to the present invention for an energy reserve store.

FIG. 2 shows a schematic flow diagram of an exemplary embodiment of a charging method according to the present invention for an energy reserve store, which method can be executed by the charging arrangement according to the present invention of FIG. 1.

FIG. 3 shows a diagram of characteristic curves during a charging process of an energy reserve store, which charging process is carried out by a conventional charging arrangement.

FIG. 4 shows a first diagram of characteristic curves during a first charging process of an energy reserve store, which is carried out by the charging arrangement according to the present invention of FIG. 1.

FIG. 5 shows a second diagram of characteristic curves during a second charging process of an energy reserve store, which is carried out by the charging arrangement according to the present invention of FIG. 1.

### DETAILED DESCRIPTION OF EXAMPLE EMBODIMENTS

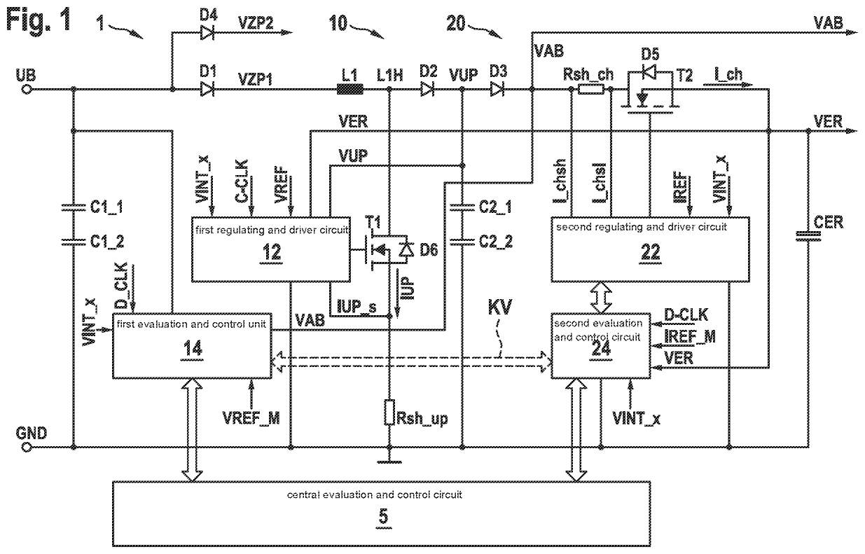

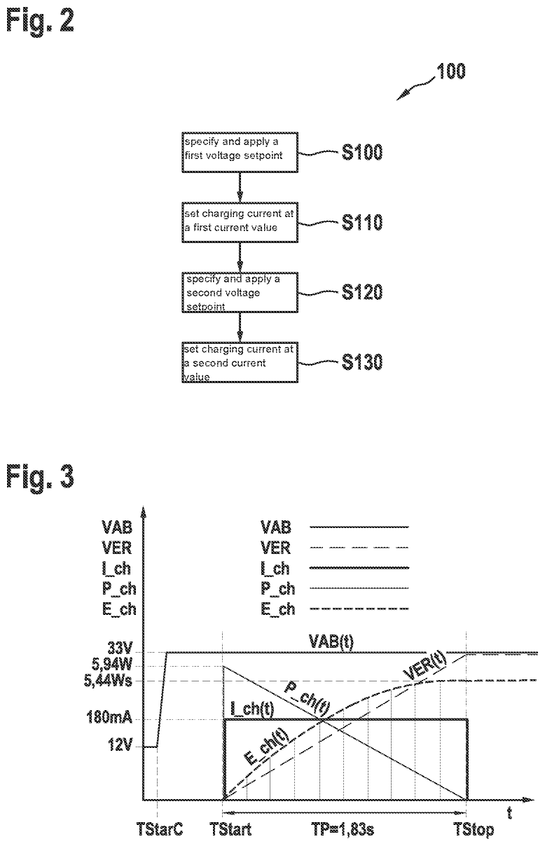

As can be seen in FIG. 1, the shown exemplary embodiment of a charging arrangement 1 according to the present invention for an energy reserve store CER comprises a central evaluation and control unit 5, which is designed to determine a charging strategy for the energy reserve store CER and to specify system-compatible current values I_ch1, I_ch2 for a charging current I_ch and voltage setpoints VAB1, VAB2; a step-up voltage transformer 10, which comprises a first regulating and driver circuit 12 with a first controlling element T1 and a first evaluation and control unit 14; and a charging circuit 20, which comprises a second regulating and driver circuit 22 with a second controlling element T2 and a second evaluation and control unit 24. In this case, the central evaluation and control unit 5 and the step-up voltage transformer 10 and the charging circuit 20 perform a charging method 100 according to the present invention, which is described below with reference to FIG. 2, for an energy reserve store CER. On the basis of specified voltage setpoints VAB1, VAB2, the step-up transformer 10 converts a respective battery voltage UB applied to the input of the step-up voltage transformer 10 to a corresponding output voltage VUP, wherein an input voltage VAB of the charging circuit 20 follows the output voltage VUP of the step-up voltage transformer 10.

As can further be seen in FIG. 1, in the exemplary embodiment shown, a protection diode D3 is looped in between the output of the step-up voltage transformer 10 and the input of the charging circuit 20. From the battery voltage UB or vehicle supply voltage applied at the input of the step-up voltage transformer 10, a first battery voltage VZP1 protected against polarity reversal is generated via a first reverse polarity protection diode D1, which first battery voltage is used for supplying a vehicle system, which is designed as an airbag system in the exemplary embodiment shown, and as the input voltage for the step-up voltage transformer 10. In addition, a second battery voltage VZP2 protected against polarity reversal is generated from the battery voltage UB via a second reverse polarity protection diode D2, which second battery voltage is used as a back-up supply for an ignition system of the airbag system. Two capacitors C1_1, C1_2 connected in series form a filter between a battery line at the potential of the battery voltage UB and a ground line at a ground potential GND. For safety reasons, two capacitors C1_1, C1_2 are used in series in order to avoid high circuit board currents in the event of a short-circuit of a component. Two further capacitors C2_1, C2_2 at the output of the step-up voltage transformer 10 form a filter between an output line at the potential of the output voltage VUP and the ground line at the ground potential GND. For safety reasons, two capacitors C2_1, C2_2 are also used in series here in order to avoid high circuit board currents in the event of a short-circuit of a component. Optionally, the series circuits can be omitted if the capacitor(s) used fulfill high flexural strength and sufficiently high quality requirements. Furthermore, the step-up voltage transformer 10 comprises a free-wheeling diode D2, which is generally designed as a Schottky diode, and a transformer inductance L1. In the exemplary embodiment shown, the first controlling element T1 is designed as an N-channel MOSFET with backward diode D6. Of course, other semiconductor switches can also be used as the first controlling element T1. In order to sense a transformer current IUP through the first controlling element T1, a first measurement voltage IUP_s across a first measuring resistor Rsh_Up is sensed. Of course, other suitable methods for sensing current can also be used.

For regulating the output voltage VUP of the step-up voltage transformer 10, the first regulating and driver circuit 12 controls the first controlling element T1. For this purpose, an applied first reference voltage VREF, the first measurement voltage IUP_s, which represents the current transformer current IUP, and the sensed output voltage VUP of the step-up voltage transformer 10 are evaluated. In the shown exemplary embodiments of the present invention, a sensed current voltage value of the energy reserve voltage VER is additionally evaluated. As a result, an overvoltage of the energy reserve voltage can be detected, for example. Furthermore, depending on the semiconductor process of the charging arrangement 1, one or more supply voltages Vint_x and a transformer clock signal C_CLK with a frequency of, for example, 2 MHz are applied to the first regulating and driver circuit 12. One or more supply voltages Vint_x, a digital clock signal D_CLK for clocking logic circuits, a second reference voltage VREF_M are applied to the first evaluation and control unit 14 depending on the semiconductor process of the charging arrangement 1, which second reference voltage is independent of the first reference voltage VREF and is used to monitor the output voltage VUP. In order to determine a minimum output voltage VUP of the step-up voltage transformer 10, the battery voltage UB is applied to the first evaluation and control unit 14 in the exemplary embodiment shown. Alternatively, the battery voltage VZP1 protected against polarity reversal can be applied to the first evaluation and control unit 14. By monitoring the battery voltage UB, the energy supply to connected electronic units is to be ensured during the charging processes, in particular if the currently applied battery voltage UB is lower than a minimum value of the supply voltage for the connected electronic unit. In addition, the battery voltage UB is used to determine a maximum possible output current of the step-up voltage transformer 10, which output current is passed directly to the second evaluation and control unit 24 for the battery voltage-dependent setting of the charging current IC and/or to the central control and evaluation unit 5. The first evaluation and control unit 14 provides the first regulating and driver circuit 12 with at least one activation signal, voltage setpoints for the output voltage VUP, on which voltage setpoints the voltage setpoints VAB1, VAB2 for the input voltage VAB of the charging circuit 20 are based, and limit values for the transformer current IUP as well as the digital clock signal D_CLK as needed.

From the central evaluation and control unit 5, the first evaluation and control unit 14 receives various control signals and information for local processing and, for example, provides the central evaluation and control unit 5 with information on the battery voltage UB, the battery voltage VZP1 protected against polarity reversal, the output voltage VUP of the step-up voltage transformer 10, the transformer current IUP, the current state of charge of the energy reserve store CER, etc. for monitoring purposes.

As can further be seen in FIG. 1, the charging circuit 20 comprises a second measuring resistor Rsh_ch, at whose end facing the input of the charging circuit a second measurement voltage I_chsh and at whose end facing the second controlling element T2 a third measurement voltage I_chsl are sensed. In this case, the two measurement voltages I_chsh, Ichsl are evaluated in order to ascertain or regulate a charging current I_ch through the second controlling element T2. Other measurement methods of the charging current I_ch including the sign (direction) can also be used. The measured charging current I_ch is passed to the second evaluation and control unit 24 for monitoring purposes and is thus also available at the higher level to the central evaluation and control unit 5. In the exemplary embodiment shown, the second controlling element T2 is designed as an N-channel MOSFET with backward diode D5. Of course, semiconductor switches other than the second controlling element T2 can also be used.

For regulating the charging current I_ch of the charging circuit 20, the second regulating and driver circuit 22 controls the second controlling element T2. For this purpose, an applied first reference current IREF as well as the two measurement voltages I_chsh, I_chsl, which represent the current charging current I_ch, are evaluated. For reducing or switching off the charging current I_ch by means of the second regulating and driver circuit 22 in the exemplary embodiment shown, the temperature of the second controlling element T2 is sensed, evaluated and passed to the second evaluation and control unit 24, and is thus also available at the higher level to the central evaluation and control unit 5. Furthermore, depending on the semiconductor process of the charging arrangement 1, one or more supply voltages Vint_x are applied to the second regulating and driver circuit 22. One or more supply voltages Vint_x, a digital clock signal D_CLK for clocking logic circuits, and a second reference voltage VREF_M, which is independent of the first reference voltage IREF and is used to monitor the charging current I_ch, are applied to the second evaluation and control unit 24 depending on the semiconductor process of the charging arrangement 1. The second evaluation and control unit 24 provides the second regulating and driver circuit 22 with at least one activation signal and current setpoints for the charging current I_ch as well as the digital clock signal D_CLK as needed. Likewise, the second evaluation and control unit 24 automatically stops the charging process of the energy reserve store CER in the different charging phases TP1, TP2 when the voltage setpoint VAB1, VAB2 specified by the central evaluation and control unit 5 or the target voltage value of the energy reserve voltage VER is reached. Optionally, the central evaluation and control unit 5 evaluates a temperature of the second regulating and driver circuit 22 and/or continuously calculates therefrom a permitted maximum power loss of the second controlling element T2 in the individual charging phases TP1, TP2. As a result, with the specified voltage setpoint VAB1, VAB2 in a corresponding charging phase TP1, TP2 and with knowledge of the current value of the energy reserve voltage VER, the current value I_ch1, Ich2 of the charging current can be optimally adapted in order to reach a maximum charging speed.

From the central evaluation and control unit 5, the second evaluation and control unit 24 receives various control signals and information for local processing, such as start or stop charging process of the energy reserve store CER; specification of the current values I_ch1, I_ch2 for the charging current I_ch for the individual charging phases TP1, TP2. The second evaluation and control unit 24, for example, provides the central evaluation and control unit 5 with information on the charging current I_ch for monitoring purposes, on the current value of the energy reserve voltage VER for indirect transmission to the first evaluation and control unit 14 as well as for monitoring and for evaluation purposes, on the temperature of the second controlling element T2 for monitoring and for temperature-dependent setpoint specification of the charging currents in the individual charging phases TP1, TP2 so that interventions of the second evaluation and control unit 24 in the charging process due to exceeding the maximum temperature limits of the second controlling element T2 are avoided except for special cases.

With reference to FIGS. 2 to 5, various charging processes and an exemplary embodiment of the charging method 100 according to the present invention for an energy reserve store CER are described below, which are carried out with the exemplary embodiment shown in FIG. 1 of the charging arrangement 1 according to the present invention.

The exemplary embodiment shown in FIG. 2 of the charging method 100 according to the present invention for an energy reserve store CER is performed in multiple stages with at least two charging phases TP1, TP2. For this purpose, in a step S100, for a first charging phase TP1, a first voltage setpoint VAB1 for the input voltage VAB of the charging circuit 20 is specified and applied to the input of the charging circuit 20, which voltage setpoint is less than a target voltage value of the energy reserve voltage VER to which the charging circuit 20 is to charge the energy reserve store CER. In a step S110, in the first charging phase TP1, the charging current I_ch is specified at a first current value I_ch1 and is set in the charging circuit 20, which charging current charges the energy reserve store CER to the first voltage setpoint VAB1 in the first charging phase TP1. In a step S120, for at least one further charging phase TP2, at least one further voltage setpoint VAB2 for the input voltage VAB of the charging circuit 20 is specified and applied to the input of the charging circuit 20, which further voltage setpoint is greater than the first voltage setpoint VAB1. In step S130, in the at least one further charging phase TP2, at least one further current value I_ch2 for the charging current I_ch is specified and set in the charging circuit 20, which further current value charges the energy reserve store CER in the at least one further charging phase TP2 to the at least one further voltage setpoint VAB2.

In order to perform the charging method 100, the first evaluation and control unit 14 in the exemplary embodiment shown activates the step-up voltage transformer 10 in a non-sleep operation of the airbag system if the battery voltage UB exceeds a minimum threshold value, provided that there is no other information, such as a too high a chip temperature, relevant overvoltage errors in the airbag system, programming, etc., from the central evaluation and control unit 5.

According to the system boundary conditions, the central evaluation and control unit 5 decides on the charging strategy for the energy reserve store CER of the system, which energy reserve store is connected via the programmable charging circuit 20. In this case, system-compatible current values I_ch1, I_ch2 for the charging current I_ch are specified in order to charge the energy reserve store CER to the specified target voltage value in a certain period of time.

FIG. 3 shows a diagram of characteristic curves of relevant variables of a conventional one-stage charging process from the related art with only one charging phase TP for the energy reserve store CER, which has a capacity of 10 mF.

As can be seen in FIG. 3, prior to activation of the step-up voltage transformer 10, the input voltage VAB of the charging circuit 20 already has a voltage value of approximately 12 volts, which corresponds to the value of the battery voltage UB decreased by the voltage drop of the diodes D1, D2 and D3. The step-up voltage transformer 10 increases this voltage value of the input voltage VAB of the charging circuit 20 relatively rapidly after a start time TStartC to a specified voltage setpoint of, for example, 33 volts. When a specified voltage threshold of, for example, 31 volts is reached, the supply of the airbag system from this voltage is started, whereby all required system voltages are generated and the central evaluation and control unit 5 is also supplied. According to the system boundary conditions, the central evaluation and control unit 5 decides on the charging strategy and specifies a corresponding current value for the charging current I_ch in order to charge the energy reserve store CER to the desired target voltage of 33 volts in a certain period of time of, for example, 1.83 seconds. The current value for the charging current I_ch is set at a charging start time TStart by the second regulating and driver circuit 22 in combination with the second evaluation and control unit 24 via the second controlling element T2. In this case, high power losses P_ch, (P_ch (t)=I_ch*(VAB(t)−VER(t)) occur at the charging circuit 20 as a function of the charging progress of the energy reserve store CER and the selected current value for the charging current I_ch. At the beginning of the shown charging process, the energy reserve store CER is uncharged so that the current voltage value VER of the energy reserve store CER corresponds to 0 volts (VER(t=0)=0V). The highest losses P_ch, (P_ch_peak(t=0)=I_ch*VAB) occur at the charging start time TStart. Thus, at a specified current value of 180 mA for the charging current I_ch and a voltage drop of 33 volts across the charging circuit 20, which voltage drop results from the difference between the voltage setpoint of 33 volts for the input voltage VAB and the current voltage value of the energy reserve voltage VER of 0 volts, a peak value for the power loss P_ch of 5.94 watts results. At a stop time TStop, the charging process is ended and the charging current I_ch is switched off again. The thermal energy E_ch, (E_ch=1/2*P_ch_peak*TP) generated in the second controlling element T2 over the charging phase TP is 5.44 Ws.

The exemplary embodiment shown in FIG. 1 of a charging arrangement 1 according to the present invention differs in the coupling of the charging circuit 20 to the step-up voltage transformer 10 via the additional protection diode D3, which is arranged between the output of the step-up voltage transformer 10 and the input of the charging circuit 20. This protection diode D3 avoids destruction in the event of an internal or external short-circuit of the output voltage VUP of the step-up voltage transformer 10 to ground GND by a reverse current from the energy reserve store CER via the backward diode D5 of the second controlling element T2. In addition to the output voltage VUP of the step-up voltage transformer 10, the input voltage VAB of the charging circuit 20, which also serves to supply the airbag system, is also sensed for monitoring purposes, whereby the function of the added protection diode D3 can additionally be checked.

In order to optimize the surface area of the second controlling element T2 in embodiments of the present invention, the regulation of the output voltage VUP of the step-up voltage transformer 10 and thus the regulation of the input voltage VAB of the charging circuit 20 is made dependent on the charging progress of the energy reserve store CER. To this end, the current voltage value of the energy reserve voltage VER is additionally supplied to the first regulating and driver circuit 12 of the step-up voltage transformer 10. The transition from the first charging phase TP1 after the second charging phase TP2 can take place by corresponding programming of the first evaluation and control unit 14 and the second evaluation and control unit 24 in a manner directly controlled via the central evaluation and control unit 5. Alternatively, the central evaluation and control unit 5 may specify an automatic charging mode. In order to coordinate the first evaluation and control unit 14 of the step-up voltage transformer 10 and the second evaluation and control unit 24 of the charging circuit 20, data exchange between the two evaluation and control units 14, 24 can be carried out in an automatic charging mode via a communication link KV shown dashed in FIG. 1, in particular for transmitting the maximum possible output current value of the step-up transformer 10 as a function of the current supply voltage UB or of the current battery voltage VZP1 protected against polarity reversal and of the selected output voltage VUP of the step-up voltage transformer 10. Alternatively, the direct communication link KV can be omitted through corresponding configuration of the central evaluation and control unit 5, wherein the central evaluation and control unit 5 then assumes this task. Furthermore, the supply of the airbag system from the input voltage VAB of the charging circuit 20 is already started at a lower threshold value of, for example, 15.5 volts.

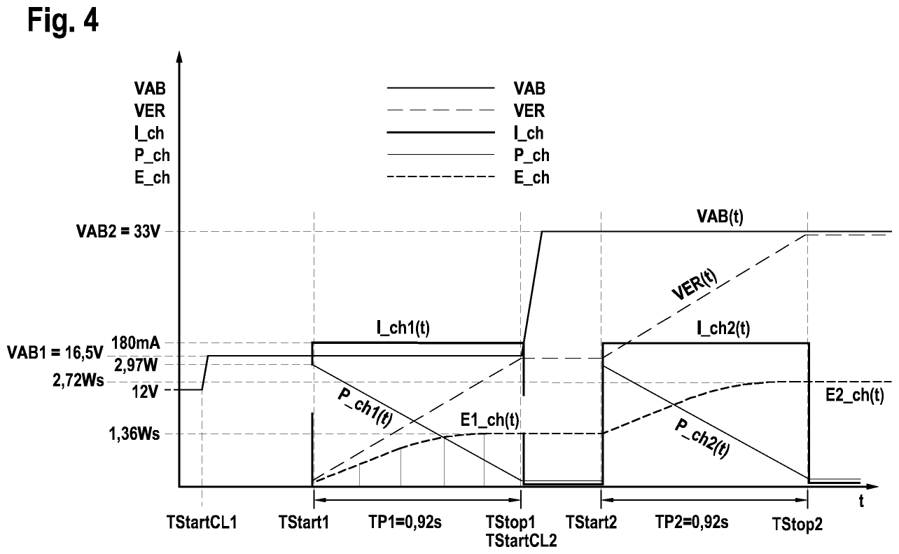

FIG. 4 shows a diagram of characteristic curves of relevant variables of a first charging process according to the present invention with two charging phases TP1, TP2 for the energy reserve store CER, which has a capacity of 10 mF.

As can be seen in FIG. 4, in the shown first exemplary embodiment, two voltage setpoints VAB1, VAB2 for the step-up voltage transformer 10 are applied. In this case, a first voltage setpoint VAB1 for a first charging phase TP1 has a value of 16.5 volts and a second voltage setpoint VAB2 for a second charging phase TP2 has a value of 33 volts, which corresponds to a target voltage value to which the energy reserve store CER is to be charged.

As can further be seen in FIG. 4, prior to activation of the step-up voltage transformer 10, the input voltage VAB of the charging circuit 20 already has a voltage value of approximately 12 volts, which corresponds to the value of the battery voltage UB decreased by the voltage drop of the diodes D1, D2 and D3. The step-up voltage transformer 10 increases this voltage value of the input voltage VAB of the charging circuit 20 relatively rapidly after a first start time TStartCL1 to a specified first voltage setpoint VAB1 of 16.5 volts. When the reduced specified voltage threshold of, for example, 15.5 volts is reached, the supply of the airbag system from this voltage is started, whereby all required system voltages are generated and the central evaluation and control unit 5 is also supplied. According to the system boundary conditions, the central evaluation and control unit 5 decides on the charging strategy and specifies a corresponding current value I_ch1 at 180 mA for the charging current I_ch in order to charge the energy reserve store CER to the specified first voltage setpoint VAB1 of 16.5 volts in the first charging phase TP1 in a certain period of time of, for example, 0.92 seconds. The first current value I_ch1 for the charging current I_ch is set at a first charging start time TStart1 by the second regulating and driver circuit 22 in combination with the second evaluation and control unit 24 via the second controlling element T2. In this case, in the first charging phase TP1, power losses P_ch (P_ch(t)=I_ch1*(VAB1(t)−VER (t)) which are reduced in comparison to the traditional one-stage charging process occur at the charging circuit 20 as a function of the charging progress of the energy reserve store CER and the selected first current value I_ch1 for the charging current I_ch. At the beginning of the first charging phase TP1, the energy reserve store CER is uncharged so that the current voltage value VER of the energy reserve store CER corresponds to 0 volts (VER(t=0)=0V). The highest losses P_ch1, (P_ch1_peak(t=0)=I_ch1*VAB1) occur at the first charging start time TStart1. Thus, at the specified current value I_ch1 of 180 mA for the first charging current I_ch and a voltage drop of 16.5 volts across the charging circuit 20, which voltage drop results from the difference between the first voltage setpoint VAB1 of 16.5 volts for the input voltage VAB and the current voltage value of the energy reserve voltage VER of 0 volts, a peak value for the power loss P_ch1 of only 2.97 watts results. This peak value of the power loss P_ch is reduced by 50% in comparison to the traditional one-stage charging process. At a first stop time TStop1, the first charging phase is ended and the charging current I_ch is switched off again. The thermal energy E_ch1 (E_ch1=1/2*P_ch1 peak*TP1) caused in the second controlling element T2 over the first charging phase TP1 is 1.36 Ws.

As can further be seen in FIG. 4, the step-up voltage transformer 10 is activated again at a second start time TStartCL2, which corresponds to the first stop time TStop1 of the first charging phase TP1. Alternatively, after the stop time TStop1 of the first charging phase TP1, a waiting period can be provided prior to the start of the step-up voltage transformer 10. After the second start time TStartCL2, the step-up voltage transformer 10 increases the input voltage VAB of the charging circuit 20 relatively rapidly from the first voltage setpoint VAB1 of 16.5 volts to the specified second voltage setpoint VAB2 of 33 volts. According to the system boundary conditions, the central evaluation and control unit 5 specifies the second current value I_ch2 at 180 mA for the charging current I_ch in order to charge the energy reserve store CER to the specified second voltage setpoint VAB2 of 33 volts in the second charging phase TP2 in a certain period of time of, for example, 0.92 seconds. The second current value I_ch2 for the charging current I_ch is set at a second charging start time TStart2 by the second regulating and driver circuit 22 in combination with the second evaluation and control unit 24 via the second controlling element T2. In this case, in the second charging phase TP2, power losses P_ch2, (P_ch2(t)=I_ch2*(VAB2(t)−VER(t)) which are reduced in comparison to the traditional one-stage charging process occur at the charging circuit 20 as a function of the charging progress of the energy reserve store CER and the selected second current value I_ch1 for the charging current I_ch, which power losses correspond to the power losses P_ch1 in the first charging phase TP1. At the beginning of the second charging phase TP2, the energy reserve store CER is charged to the first voltage setpoint VAB1 so that the voltage drop across the charging circuit corresponds to the different between the second voltage setpoint VAB2 and the first voltage setpoint VAB1. At the second charging start time Tstart2, the same peak value of 2.97 watts for the losses P_ch2 therefore occur as at the first charging start time Tstart1. At a second stop time TStop2, the second charging phase TP2 and the first charging process according to the present invention are ended and the charging current I_ch is switched off again. The thermal energy E_ch2 (E_ch=1/2*P_ch2_peak*TP2) caused in the second controlling element T2 over the second charging phase TP1 is 1.36 Ws. The second controlling element T2 thus causes a thermal energy E_ch, (E_ch=E_ch1+E_ch2) of 2.72 Ws over the entire first charging process according to the present invention.

Since, due to the direct coupling to the vehicle battery and the battery voltage UB, the output voltage VUP of the step-up voltage transformer 10 in the exemplary embodiment shown always assumes a level of the battery voltage reduced by the forward voltage of the diodes D1, D2, the first voltage setpoint UAB1 cannot be freely selected. The second controlling element T2 of the charging circuit 20 is therefore to be dimensioned at least for a power loss P_ch which results in the first charging phase TP1 from the maximum battery voltage UBmax and the forward voltages of the diodes D1, D2 and D3 and the first current value I_ch1 of the charging current, which first current value is specified for the first charging phase TP1, (P_ch1_peak=((UBmax−2Udmin)−Udmin)*I_ch1=VAB1*I_ch1), where UDmin represents the forward voltage of one diode.

In embodiments of the present invention, the peak value of the power loss P_ch and the resulting thermal energy E_ch in the voltage, current and capacity limits of the energy reserve store CER in the first charging phase TP1 define the dimensioning of the second controlling element T2, which can have a smaller surface area at the same performance capability. In addition, further charging phases with corresponding further fixed voltage setpoints and current setpoints can be introduced.

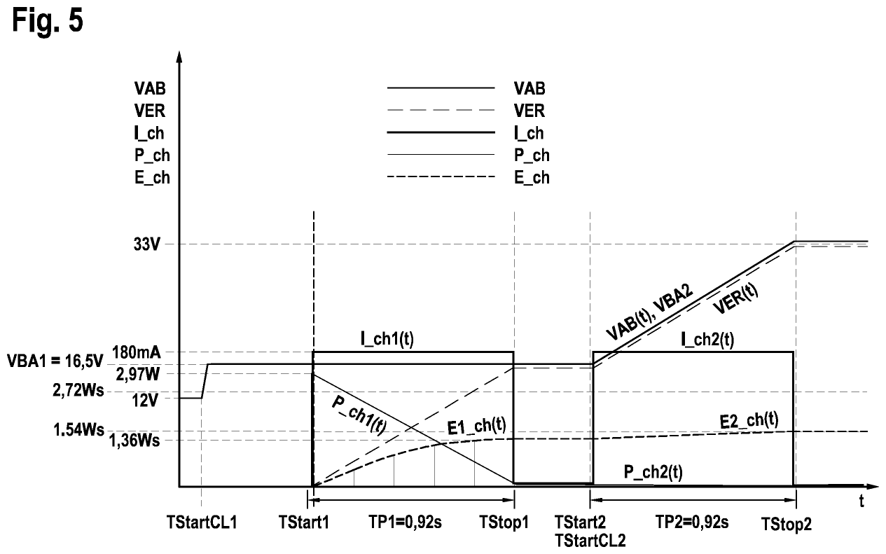

FIG. 5 shows a diagram of characteristic curves of relevant variables of a second charging process according to the present invention with two charging phases TP1, TP2 for the energy reserve store CER, which has a capacity of 10 mF.

As can be seen in FIG. 5, in the second exemplary embodiment shown, a fixed first voltage setpoint VAB1 for the first charging phase TP1 and a variable second voltage setpoint VAB2 of the step-up voltage transformer 10 are applied. In this case, the first voltage setpoint VAB1 for the first charging phase TP1 has a value of 16.5 volts and the second voltage setpoint VAB2 for the second charging phase TP2 is continuously adjusted to follow the current voltage value of the energy reserve voltage VER. Due to the greatly reduced power loss P_ch2 in the second charging phase, even at a higher second current value I_ch2 for the charging current I_ch, the dimensioning of the second controlling element T2 according to the load in the first charging phase TP1 is not significantly additionally loaded by the second charging phase TP2, since only highly reduced heating occurs here.

As can further be seen in FIG. 5, the first charging phase TP1 remains unchanged in comparison to the first exemplary embodiment shown in FIG. 4 since the first charging phase TP1 cannot be changed for system-related reasons. In the second charging phase TP2, in which the energy reserve voltage VER is raised above the maximum potential of the battery voltage UB, the changeable second voltage setpoint VAB2 continuously follows the increase in the energy reserve voltage VER starting from the first voltage setpoint VAB1 of 16.5 Volt until the desired target voltage value of 33 volts is reached, to which the energy reserve store CER is to be charged. As a result, nearly power loss-free charging of the energy reserve store CER in the second charging phase TP2 is possible. As a result, the generated total thermal energy E_ch in the second controlling element T2 can be reduced further, and the charging time can additionally be reduced by raising the second current value I_ch2 for the charging current I_ch fixedly or variably in the second charging phase TP2.

As can further be seen in FIG. 5, the step-up voltage transformer 10 is activated again at a second start time TStartCL2, which corresponds to the first stop time TStop1 of the first charging phase TP1. Alternatively, after the stop time TStop1 of the first charging phase TP1, a waiting period can be provided prior to the start of the step-up voltage transformer 10. After the second start time TStartCL2, the step-up voltage transformer 10 increases the input voltage VAB of the charging circuit 20 continuously from the first voltage setpoint VAB1 of 16.5 volts to the desired target voltage value of the energy reserve voltage VER. This means that the specified second voltage setpoint VAB2 is variably increased from 16, 5 volts to 33 volts. According to the system boundary conditions, the central evaluation and control unit 5 specifies the second current value I_ch2 at 180 mA for the charging current I_ch in order to charge the energy reserve store CER to the specified target voltage value of the energy reserve voltage VER of 33 volts in the second charging phase TP2 in a certain period of time of, for example, 0.92 seconds. The second current value I_ch2 for the charging current I_ch is set at a second charging start time TStart2 by the second regulating and driver circuit 22 in combination with the second evaluation and control unit 24 via the second controlling element T2. In this case, in the second charging phase TP2, nearly no power loss P_ch2, (P_ch2(t)=I_ch2*(VAB2(t)−VER(t)=I_ch2*[VER(t)+Udrop−VER(t)]=I_ch2*Udrop), in comparison to the first charging phase TP1 occurs on the second controlling element T2 since the second voltage setpoint VAB2 is variable and is adjusted to follow the current energy reserve voltage VER except for a required drop voltage Udrop. For this purpose, the current energy reserve voltage VER is evaluated by the central evaluation and control unit 5 and transferred to the first evaluation and control unit 14 for adjusting the output voltage VUP of the step-up voltage transformer 10 so that the following applies to the variable second voltage setpoint VAB2: VAB2(t)=Udrop+VER(t), wherein the drop voltage Udrop is less than or equal to 1 to 3 volts. Since the second voltage setpoint VAB2 or the input voltage VAB of the charging circuit 20 continuously follows the energy reserve voltage VER, only a minimum voltage drop across the charging circuit 20 results in the second charging phase TP2 and therefore also only very low losses P_ch2. With an assumed constant drop voltage Udrop of 2 V and a second current value Ich2 of 180 mA, a loss P_ch2 of about 0.36 watts results. The thermal energy E_ch2, (E_ch2=1/2*P_ch2_peak*TP2) with TP2=0.92 s, generated in the second controlling element T2 in the second charging phase TP2 is about 0.33 Ws. The second controlling element T2 thus causes a thermal energy E_ch, (E_ch=E_ch1+E_ch2), of 1.69 Ws over the entire second charging process according to the present invention.

1-15. (canceled)

16. A charging method for an energy reserve store configured as a capacitor, wherein the charging method is performed in multiple stages with at least two charging phases, the charging method comprising the following steps:
for a first charging phase of the at least two charging phases, specifying a constant first voltage setpoint for an input voltage of a charging circuit and applying the first voltage setpoint to an input of the charging circuit, which first voltage setpoint is less than a target voltage value of an energy reserve voltage to which the charging circuit is to charge the energy reserve store, wherein, in the first charging phase, a charging current is specified at a first current value and is set in the charging circuit, the charging current charges the energy reserve store to the first voltage setpoint in the first charging phase; and
for at least one further charging phase of the at least two charging phases, specifying at least one further voltage setpoint for the input voltage of the charging circuit and applying the further voltage setpoint to the input of the charging circuit, wherein the further voltage setpoint is greater than the first voltage setpoint, wherein, in the at least one further charging phase, at least one further current value for the charging current is specified and is set in the charging circuit, the further current value charging the energy reserve store to the at least one further voltage setpoint in the at least one further charging phase;
wherein the first voltage setpoint for the input voltage of the charging circuit: (i) is determined based on a minimum value of an output voltage of a step-up voltage converter, which minimum value is based on a battery voltage, or (ii) is determined based on a specified minimum value of a supply voltage for a connected electronic unit when a currently applied battery voltage is lower than the minimum value of the supply voltage for the connected electronic unit.

17. The charging method according to claim 16, wherein a certain number of further charging phases with corresponding gradual voltage setpoints for the input voltage of the charging circuit are fixedly specified.

18. The charging method according to claim 17, wherein, in a final charging phase of the certain number of further charging phases, the target voltage value of the energy reserve voltage is fixedly specified as a voltage setpoint for the input voltage of the charging circuit.

19. The charging method according to claim 16, wherein, in a second charging phase, the charging current is specified at a second current value and is set in the charging circuit, wherein the charging current charges the energy reserve store in the second charging phase to the target voltage value of the energy reserve voltage starting from the first voltage setpoint, wherein, during the second charging phase, a current voltage value of the energy reserve voltage is continuously sensed, wherein the at least one further voltage setpoint for the input voltage of the charging circuit is variably specified based on the sensed current voltage value of the energy reserve voltage starting from the first voltage setpoint and is applied to the input of the charging circuit.

20. The charging method according to claim 16, wherein the first current value of the charging current in the first charging phase and/or the at least one further current value of the charging current in the at least one further charging phase, is set as a function of a desired charging speed.

21. The charging method according to claim 16, wherein the first current value of the charging current in the first charging phase and/or the at least one further current value of the charging current in the at least one further charging phase, is specified as a function of a maximum possible output current of the step-up voltage transformer.

22. The charging method according to claim 16, wherein the first current value of the charging current in the first charging phase and/or the at least one further current value of the charging current in the at least one further charging phase, is limited as a function of: (i) a resulting power loss in the charging circuit and/or (ii) a current temperature of a corresponding regulating and driver circuit and/or of a controlling element of the charging device.

23. A charging arrangement for an energy reserve store configured as a capacitor, comprising:
a central evaluation and control unit configured to determine a charging strategy for the energy reserve store and to specify system-compatible current values for a charging current and voltage setpoints;
a step-up voltage transformer including a first regulating and driver circuit with a first controlling element and a first evaluation and control unit; and
a charging circuit including a second regulating and driver circuit with a second controlling element and a second evaluation and control unit;
wherein the central evaluation and control unit, the step-up voltage transformer, and the charging circuit are configured to perform a charging method in multiple stages with at least two charging phases, the charging method comprising the following steps:
for a first charging phase of the at least two charging phases, specifying a constant first voltage setpoint for an input voltage of the charging circuit and applying the first voltage setpoint to an input of the charging circuit, which first voltage setpoint is less than a target voltage value of an energy reserve voltage to which the charging circuit is to charge the energy reserve store, wherein, in the first charging phase, a charging current is specified at a first current value and is set in the charging circuit, the charging current charges the energy reserve store to the first voltage setpoint in the first charging phase; and
for at least one further charging phase of the at least two charging phases, specifying at least one further voltage setpoint for the input voltage of the charging circuit and applying the further voltage setpoint to the input of the charging circuit, wherein the further voltage setpoint is greater than the first voltage setpoint, wherein, in the at least one further charging phase, at least one further current value for the charging current is specified and is set in the charging circuit, the further current value charging the energy reserve store to the at least one further voltage setpoint in the at least one further charging phase;
wherein, based on specified voltage setpoints including the first voltage setpoint and the at least one further voltage setpoint, the step-up transformer converts a respective battery voltage applied to the input of the step-up voltage transformer to a corresponding output voltage, wherein the input voltage of the charging circuit follows the output voltage of the step-up voltage transformer, wherein the first voltage setpoint for the input voltage of the charging circuit is determined based on a minimum value of the output voltage of the step-up voltage converter, the minimum value of the output voltage of the step-up voltage converter is based on a battery voltage, or is determined based on a specified minimum value of a supply voltage for a connected electronic unit if a currently applied battery voltage is lower than the minimum value of the supply voltage for the connected electronic unit.

24. The charging arrangement according to claim 23, wherein a protection diode is looped in between the output of the step-up voltage transformer and the input of the charging circuit.

25. The charging arrangement according to claim 23, wherein the central evaluation and control unit and the first regulating and driver circuit and the first evaluation and control unit of the step-up voltage transformer are configure to, for controlling the first controlling element of the step-up voltage transformer, sense and evaluate: a battery voltage and/or an input voltage of the step-up transformer and/or the output voltage of the step-up voltage transformer and/or the input voltage of the charging circuit and/or a current voltage value of the energy reserve voltage and/or a transformer current through the first controlling element.

26. The charging arrangement according to claim 23, wherein the central evaluation and control unit, and the second regulating and driver circuit and the second evaluation and control unit of the charging device, are configured, for controlling the second controlling element of the charging device, to regulate the charging current according to a fixed or variable setpoint specification.

27. The charging arrangement according to claim 23, wherein the central evaluation and control unit, and the second regulating and driver circuit, and the second evaluation and control unit of the charging device, are configured, for controlling the second controlling element of the charging device, (i) to measure and evaluate the charging current in the charging direction and/or the discharging direction, and/or (ii) to measure and evaluate the current voltage of the energy reserve store, and/or (iii) to measure and evaluate a temperature of the second controlling element and/or of the second regulating and driver circuit, and/or (iv) to calculate a power loss of the second controlling element.

28. The charging arrangement according to claim 23, wherein a communication link for data exchange between the first evaluation and control unit of the step-up voltage transformer and the second evaluation and control unit of the charging circuit is formed.
